(19) United States
(12) Patent Application Publication
(10) Pub. No.: US 2022/0276659 A1
(43) Pub. Date: Sep. 1, 2022

(54) ENVIRONMENT MAP CREATION DEVICE AND METHOD, LOCAL POSITION ESTIMATION DEVICE, AND AUTONOMOUS MOVING BODY

(71) Applicant: YAMAHA HATSUDOKI KABUSHIKI KAISHA, Iwata-shi, Shizuoka-ken (JP)

(72) Inventors: Kenta MIZUI, Shizuoka (JP); Haruyasu FUJITA, Shizuoka (JP)

(73) Assignee: YAMAHA HATSUDOKI KABUSHIKI KAISHA, Iwata-shi, Shizuoka-ken (JP)

(21) Appl. No.: 17/637,437

(22) PCT Filed: Sep. 26, 2019
(86) PCT No.: PCT/JP2019/037891

§ 371 Date: Feb. 22, 2022

(51) Int. Cl. G05D 1/02; G01S 13/89; G01S 15/89; G01S 17/89

(52) U.S. Cl. CPC G05D 1/0274; G01S 13/89; G01S 15/89; G01S 17/89; B60W 60/001

(57) ABSTRACT

An environment map creation device and an environment map creation method according to the present disclosure include creating an environment map for estimating a self-position, based on a first sub-environment map created as an environment map in a first environment and a second sub-environment map created as an environment map in a second environment different from the first environment while including the first environment. A self-position estimation system estimates the self-position by using the environment map for estimating the self-position based on the first sub-environment map in the first environment and the second sub-environment map in the second environment. Further, an autonomous mobile vehicle includes the self-position estimation system and performs autonomous movement.

### CROSS-REFERENCE TO RELATED APPLICATION

This application is a National Stage of International Patent Application No. PCT/JP2019/037891, filed Sep. 26, 2019, the entire content of which is incorporated herein by reference.

### BACKGROUND

### Technical Field

The present disclosure relates to an environment map creation device and an environment map creation method for creating an environment map for estimating a self-position so as to estimate an own position (self-position) of the device, and a self-estimation system which estimates its own position (self-position) and an autonomous mobile vehicle including the self-position estimation system.

### Background Art

For instance, autonomous mobile vehicles, such as autonomous mobile robots, which move under a self-judgement (under their own judgement of the robots) are applicable to various purposes. For example, the autonomous mobile vehicles are available for logistics purposes, cleaning purposes, and security purposes in facilities including factories and buildings, and further available for works in dangerous environments and other environments which are less accessible to people, like the seabed and planets. Such an autonomous mobile vehicle needs to recognize a self-position of the mobile vehicle to move under a self-judgement thereof. Accordingly, self-position estimation technologies of each estimating a self-position have been studied and developed, as described, for example, in Japanese Unexamined Patent Publication No. 2013-73250.

The self-position estimation technologies include known technologies, for example: a technology (odometry way) of estimating a self-position by obtaining a moving direction and a moving distance, based on a rotational number of left and right wheels included in a vehicle; a technology of searching for a marker set in a space or a so-called landmark in a space and estimating a self-position by triangulation based on the searched marker or landmark; and a technology of estimating a self-position by recognizing where a map (a surrounding-area map, a local map) measured and obtained in an autonomous movement is located on a preliminarily measured or prepared map (an environment map, and a global map).

Each of the self-position estimation technologies needs to match the surrounding-area map and the environment map each other. Examples of the matching way include: a way (scanning matching way) using scan matching, e.g., ICP (Iterative Closest Point) Scan Matching, NDT (Normal Distribution Transform) Scan Matching, and a Polar Scan Matching; a way (particle way, Monte Carlo way) using a particle filter; and other ways using both the scan matching and the particle filter. The scan matching using, for example, the ICP includes obtaining corresponding points at nearest neighbor points between two point groups, i.e., between a data group of the surrounding-area map and a data group of the environment map, and obtaining, as a self-position, a position where a sum of squares of a distance between the corresponding points reaches a minimum by a repetitive convergent calculation. The particle filter way includes obtaining a likelihood degree based on a superposition degree between the object on the surrounding-area map and the object on the environment map for each of N particles, and estimating a particle having the highest likelihood degree as the self-position.

Nevertheless, the self-position estimation technology using the environment map has a risk of wrongly estimating the self-position when an environment expressed by the environment map and an actual (real) environment in the estimation of the self-position differ from each other. Particularly, in a factory, an attachment is, for example, attached to and detached from a manufacturing apparatus, a parts stand is attached thereto or detached therefrom, and a workbench or work table is connected thereto or disconnected therefrom depending on manufacturing steps and various kinds of manufactured goods. Hence, the environment expressed by the environment map and the actual (real) environment in the estimation of the self-position frequently differ from each other. The frequent occurrence of difference needs to be considered significant.

### SUMMARY

The present disclosure has been achieved in view of the above-described circumstances, and provides an environment map creation device and an environment map creation method for creating an environment map for estimating a self-position so as to more accurately estimate a self-position, and a self-position estimation system using the environment map for estimating the self-position and an autonomous mobile vehicle including the self-position estimation system.

An environment map creation device and an environment map creation method according to the present disclosure include creating an environment map for estimating a self-position, based on a first sub-environment map created as an environment map in a first environment, and a second sub-environment map created as an environment map in a second environment different from the first environment while including the first environment. The self-position estimation system according to the present disclosure estimates the self-position by using the environment map for estimating the self-position, based on the first sub-environment map in the first environment and the second sub-environment map in the second environment. An autonomous mobile vehicle according to the present disclosure includes the self-position estimation system and performs autonomous movement.

### BRIEF DESCRIPTION OF THE DRAWINGS

FIG. 1 is a block diagram showing a configuration of an autonomous mobile vehicle according to an embodiment including an environment map creation device and a self-position estimation system according to the embodiment;

FIG. 2 is a flowchart showing an operation of creating an environment map for estimating a self-position in the autonomous mobile vehicle;

FIGS. 3A and 3B are views for explaining, as an example, a first environment and a first sub-environment map in the first environment;

FIGS. 4A and 4B are views for explaining, as an example, a second environment and a second sub-environment map in the second environment;

FIGS. 5A-5C are views for explaining a way of superposing the first sub-environment map and the second sub-environment map in creating the environment map for estimating the self-position;

FIGS. 6A and 6B are views for explaining, as an example, the environment map for estimating the self-position;

FIG. 7 is a flowchart showing an operation of estimating the self-position to be performed in the autonomous mobile vehicle;

FIGS. 8A-8D are views for explaining an operational effect of a first aspect for estimating a self-position in the autonomous mobile vehicle; and

FIGS. 9A and 9B includes views for explaining an operational effect of a second aspect for estimating a self-position in the autonomous mobile vehicle.

### DETAILED DESCRIPTION

Hereinafter, an embodiment of the present disclosure will be described with reference to the accompanying drawings. However, the scope of the disclosure should not be limited to the disclosed embodiments. Elements denoted by the same reference numerals in the drawings have the same configuration, and therefore repeated descriptions will be appropriately omitted. In the present specification, elements are denoted by a same reference numeral when being referred to collectively, and are denoted by a same reference numeral accompanied by a different respective reference character when being referred to individually.

An environment map creation device according to the embodiment is a device which creates an environment map for estimating a self-position. The environment map creation device includes: an environment recognition sensor which measures a direction toward an object and a distance to the object; a first creation section which creates, based on a first measurement result measured by the environment recognition sensor in a predetermined first environment, an environment map as a first sub-environment map, and creates, based on a second measurement result measured by the environment recognition sensor in a predetermined second environment different from the first environment while including the first environment, an environment map as a second sub-environment map; and a second creation section which creates, based on the first and second sub-environment maps created by the first creation section, the environment map for estimating the self-position. A self-position estimation system according to the embodiment includes: an environment map information storage part which stores the environment map for estimating the self-position; an environment recognition sensor which measures a direction toward an object and a distance to the object; and a self-position estimation part which estimates the self-position, based on a measurement result measured by the environment recognition sensor and the environment map for estimating the self-position stored in the environment map information storage part. The environment map for estimating the self-position is an environment map based on the environment map in the predetermined first environment and the environment map in the predetermined second environment different from the first environment while including the first environment. The environment map for estimating the self-position is, for example, created by the environment map creation device and stored in the environment map information storage part of the self-position estimation system. Moreover, an autonomous mobile vehicle according to the embodiment includes: the self-position estimation system; a moving part which performs movement of the autonomous mobile vehicle; and an autonomous movement control part which controls the moving part, based on the self-position estimated by the self-position estimation system. Hereinafter, the autonomous mobile vehicle will be more specifically described in combination with the environment map creation device and the self-position estimation system.

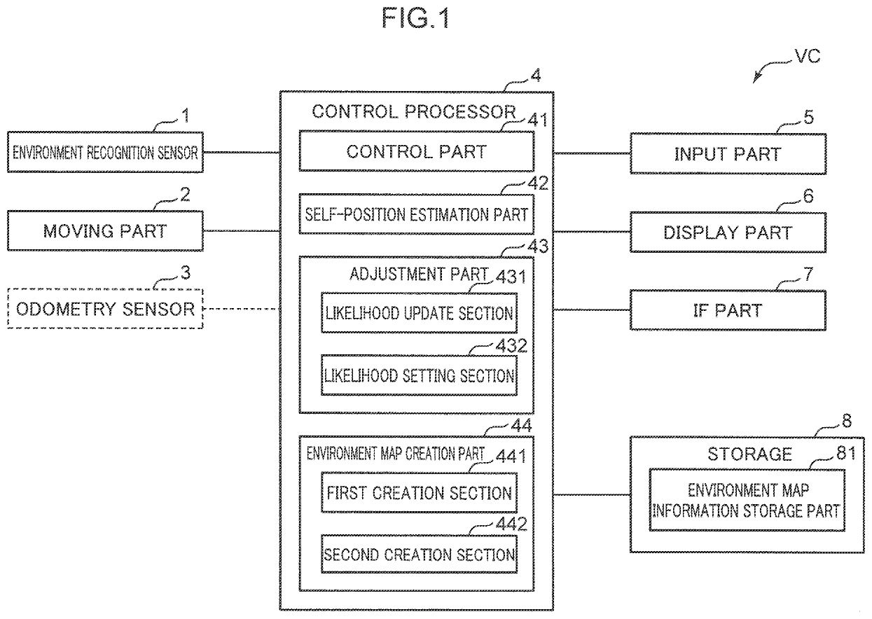

FIG. 1 is a block diagram showing a configuration of an autonomous mobile vehicle according to an embodiment including an environment map creation device and a self-position estimation system according to the embodiment.

As shown in FIG. 1, an autonomous mobile vehicle VC according to the embodiment includes, for example, an environment recognition sensor 1, a moving part 2, a control processor 4, an input part 5, a display part 6, an interface part (IF part) 7, and a storage 8.

The environment recognition sensor 1 is a sensor connected to the control processor 4 for measuring a direction toward an object existing in a predetermined space (region) and a distance to the object in accordance with a control of the control processor 4. The environment recognition sensor 1 may two-dimensionally measure the object or three-dimensionally measure the object. The environment recognition sensor 1 includes, for example, a radar using an electromagnetic wave or an ultrasonic wave, a LIDAR (Light Detection and Ranging, Laser Imaging Detection and Ranging) using pulse laser light, and a stereo camera using visible light or infrared light.

The moving part 2 is a device connected to the control processor 4 for performing movement of the autonomous mobile vehicle VC in accordance with a control of the control processor 4. For instance, the moving part 2 includes: a pair of left and right drive wheels; a motor connected to the control processor 4 for generating a drive force in accordance with a control of the control processor 4; and a decelerator which transmits the drive force generated by the motor to the drive wheels. The moving part 2 may further include, in addition to the pair of drive wheels, one or more auxiliary wheels (driven wheels) or one or more auxiliary rods slidable on a bottom surface (road surface) to come into contact with the bottom surface at, at least, three positions thereof for moving the autonomous mobile vehicle VC in a relatively stable posture.

The input part 5 is a device connected to the control processor 4 for inputting various commands and various kinds of data into the autonomous mobile vehicle VC (the environment map creation device, the self-position estimation system), and is composed of, for example, a plurality of input switches each having a predetermined function. The various commands include, for example, a command of instructing a start of creating an environment map for estimating a self-position and a command of instructing a start of performing autonomous movement. The various kinds of data include, for example, necessary data such as an identifier of the environment map (name of space for the autonomous movement) to be created for estimating the self-position. The display part 6 is a device connected to the control processor 4 for displaying the command and data input from the input part 5, and an operation state of the autonomous mobile vehicle VC in creating the environment map or in performing the autonomous movement, and other operations, and includes a display device, e.g., a CRT display, a liquid crystal display (LCD) and an organic EL display.

The input part 5 and the display part 6 may form a touch screen. In the case of forming the touch screen, the input part 5 serves as, for example, a position input device of a resistive type or capacitive type for detecting and receiving an input of a manipulation position. The touch screen has the position input device on a display surface of the display device, and displays one or more input content candidates which can be input to the display device. When a user touches a display position where an input content which the user wants to input is displayed, the position is detected by the position input device, and the display content displayed at the detected position is input to the autonomous mobile vehicle VC as a manipulation input content from the user. The touch screen having this configuration allows the user to intuitively understand the input manipulation, and thus can make the autonomous mobile vehicle VC easily operable by the user.

The IF part 7 is a circuit connected to the control processor 4 for inputting and outputting data between the IF part and an external device in accordance with a control of the control processor 4, e.g., an interface circuit in the form of RS-232C of a serial communication type, an interface circuit using the Bluetooth (registered trademark) standard, an interface circuit using the IrDA (Infrared Data Association) standard based on an infrared communication, and an interface circuit using the USB (Universal Serial Bus) standard. The IF part 7 may be a circuit which communicates with the external device, e.g., a data communication card and a communication interface circuit adopting the IEE802.11 standard.

The storage 8 is a circuit connected to the control processor 4 for storing various predetermined programs and various kinds of predetermined data in accordance with a control of the control processor 4. The various predetermined programs include, for example, control processing programs. The control processing programs include a control program, a self-position estimation program, an adjustment program, and an environment map creation program. The control program is a program for controlling the respective parts and storage 1, 2, 5 to 8 of the autonomous mobile vehicle VC in accordance with their respective operations. The environment map creation program is a program for creating an environment map for estimating a self-position, based on: an environment map created as a first sub-environment map based on a first measurement result measured by the environment recognition sensor 1 in a first environment; and an environment map created as a second sub-environment map based on a second measurement result measured by the environment recognition sensor 1 in a second environment different from the first environment while including the first environment. The self-position estimation program is a program for estimating the self-position, based on a third measurement result measured by the environment recognition sensor 1 and the environment map for estimating the self-position stored in the storage 8. The adjustment program is a program for updating the environment map for estimating the self-position, based on the third measurement result measured by the environment recognition sensor 1 and the environment map for estimating the self-position stored in the storage 8, and causing the storage 8 to store the updated environment map. The various kinds of predetermined data include data required to execute the programs, e.g., an adjustment value (weight value) γ (0<γ≤1), an increase value α (0<α<1−γ), and a decrease value β (0<β<γ) of an object presence likelihood degree LH or the environment map for estimating the self-position. The storage 8 operably includes an environment map information storage part 81 which stores the environment map for estimating the self-position. The environment map for estimating the self-position will be described in more detail later. The storage 8 includes, for example, a ROM (read only memory) that is a non-volatile storage element and an EEROM (electrically erasable programmable read only memory) that is a rewritable and non-volatile storage element. The storage 8 further includes a RAM (random-access memory) serving as a working memory of the control processor 4 for storing data obtained during the execution of each of the predetermined programs. Here, the storage 8 may include a hard disk element having a relatively large storage capacity.

The control processor 4 is a circuit for controlling each of the parts and storage 1, 2, 5 to 8 of the autonomous mobile vehicle VC, creating the environment map for estimating the self-position based on each measurement result of the environment recognition sensor 1, and performing the autonomous movement based on the measurement result of the environment recognition sensor 1. The control processor 4 may be configured to include, for example, a CPU (central processing unit) and a peripheral circuit therearound. The control processor 4 further operably includes a control part 41, a self-position estimation part 42, an adjustment part 43, and an environment map creation part 44 by executing a corresponding control processing program.

The control part 41 controls each of the parts and storage 1, 2, 5 to 8 of the autonomous mobile vehicle VC in accordance with the operability of each of these parts and storage, and controls the entirety of the autonomous mobile vehicle VC. In the embodiment, the control part 41 controls the moving part 2, based on the self-position estimated by the self-position estimation part 42, in the autonomous movement.

The environment map creation part 44 creates the environment map for estimating the self-position, based on: an environment map created as a first sub-environment map based on a first measurement result measured by the environment recognition sensor 1 in a first environment; and an environment map created as a second sub-environment map based on a second measurement result measured by the environment recognition sensor 1 in a second environment different from the first environment while including the first environment. The environment map creation part 44 operably includes a first creation section 441 and a second creation section 442.

The first creation section 441 creates, based on the first measurement result measured by the environment recognition sensor in a predetermined first environment, an environment map as the first sub-environment map, and creates, based on the second measurement result measured by the environment recognition sensor 1 in a predetermined second environment different from the first environment while including the first environment, an environment map as the second sub-environment map.

The second creation section 442 creates, based on the first and second sub-environment maps created by the first creation section 441, the environment map for estimating the self-position. More specifically, the second creation section 442 creates the environment map for estimating the self-position by superposing the first and second sub-environment maps created by the first creation section 441 so that respective peripheral portions of the first and second sub-environment maps meet each other. When creating the environment map for estimating the self-position in the superposition manner, the second creation section 442 obtains a value at a certain point on the environment map for estimating the self-position by executing the OR operation onto superposed points on the first and second sub-environment maps created by the first creation section 441. The environment map includes an object presence likelihood degree LH representing a degree of likelihood that an object exists at the certain point or a first point. The second creation section 442 sets a value of the object presence likelihood degree LH at each first point on the environment map for estimating the self-position by changing a value thereof from a set value 1 to an adjustment value (weight value) γ depending on a distance between a first sub-point corresponding to the first point on the first sub-environment map and a second sub-point corresponding to the first point on the second sub-environment map when creating the environment map for estimating the self-position (after the execution of the OR operation). In the embodiment, the object presence likelihood degree LH can take a value ranging from 0 to 1, where 1 indicates the highest likelihood degree that the object exists at the first point, and the object is less likely to exist at the first point as the value decreases from 1 to 0. More specifically, the second creation section 442 sets the value of the object presence likelihood degree LH at the first point on the environment map for estimating the self-position by changing the value thereof from the set value 1 to the adjustment value (weight value) γ when the distance between the first sub-point and the second sub-point at the first point is equal to or longer than a predetermined threshold Th that is set in advance. For instance, the threshold Th is appropriately set in advance from a plurality of samples. The adjustment value γ is appropriately set in advance within a range higher than 0 and equal to or lower than 1 from a plurality of samples as well (0<γ≤1). The object presence likelihood degree LH ranges from 0 to 1 in the embodiment, but is not limited thereto, and the degree may preferably range, for example, from 0 to 100.

The self-position estimation part 42 estimates the self-position, based on a third measurement result measured by the environment recognition sensor 1 and the environment map for estimating the self-position stored in the storage 8. A well-known way, e.g., the scan matching way and the particle filter way, is used for estimating the self-position.

The adjustment part 43 updates, based on the third measurement result measured by the environment recognition sensor 1 and the environment map for estimating the self-position stored in the storage 8, the environment map for estimating the self-position and causes the storage 8 to store the updated environment map. The adjustment part 43 operably includes a likelihood update section 431 and a likelihood setting section 432.

The likelihood update section 431 determines, based on the third measurement result measured by the environment recognition sensor 1 and the environment map for estimating the self-position stored in the storage 8, whether to update (change) the object presence likelihood degree at the first point on the environment map for estimating the self-position, and updates, based on a result of the determination, the object presence likelihood degree at the first point. More specifically, the likelihood update section 431 updates the environment map for estimating the self-position by increasing an object presence likelihood degree LH at a point, where the object is measured based on the third measurement result measured by the environment recognition sensor 1, on the environment map for estimating the self-position only by an increase value α (LH+α→LH≤upper limit), or updates the environment map for estimating the self-position by decreasing an object presence likelihood degree LH at a point, where no object is measured based on the third measurement result measured by the environment recognition sensor 1, on the environment map for estimating the self-position only by a decrease value β (LH−β→LH≥lower limit). For instance, each of the increase value α and the decrease value β is appropriately set from a plurality of samples. Each of the increase value α and the decrease value β may be an absolute value, and the two values may be the same or different from each other.

The likelihood setting section 432 stores, in the environment map information storage part 81 of the storage 8, the environment map for estimating the self-position updated by the likelihood update section 431 and sets the updated environment map.

Each of the control processor 4, the input part 5, the display part 6, the IF part 7, and the storage 8 may be composed of, for example, a computer of a desktop type or laptop type including an interface circuit for transmitting or receiving data from and to the environment recognition sensor 1 and the moving part 2.

In the embodiment, the environment recognition sensor 1 and the environment map creation part 44 of the control processor 4 form an exemplary environment map creation device. The environment recognition sensor 1, the environment map information storage part 81 of the storage 8, and the self-position estimation part 42 of the control processor 4 form an exemplary self-position estimation system. The control part 41 corresponds to an exemplary autonomous movement control part which controls the moving part, based on the self-position estimated by the self-position estimation system.

Next, operations of the autonomous mobile vehicle according to the embodiment will be described. First, an operation of creating an environment map for estimating a self-position will be described, and thereafter, operations of estimating the self-position and performing autonomous movement will be described.

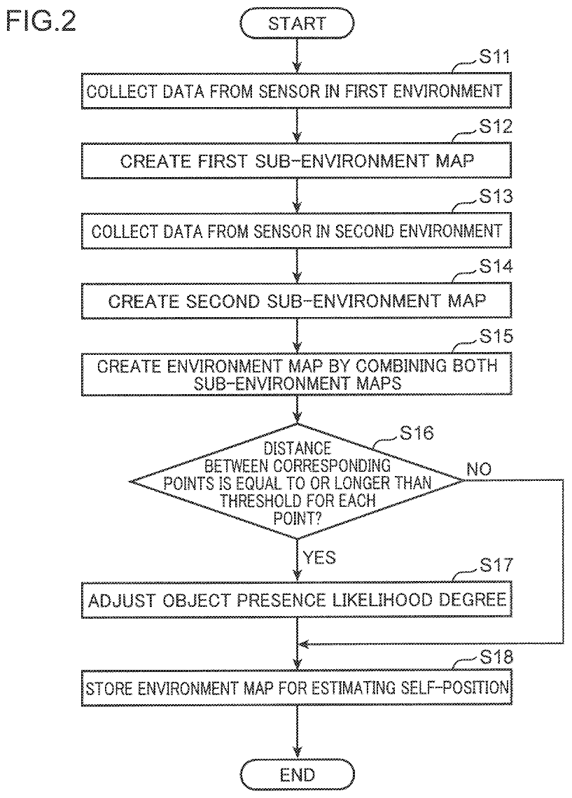

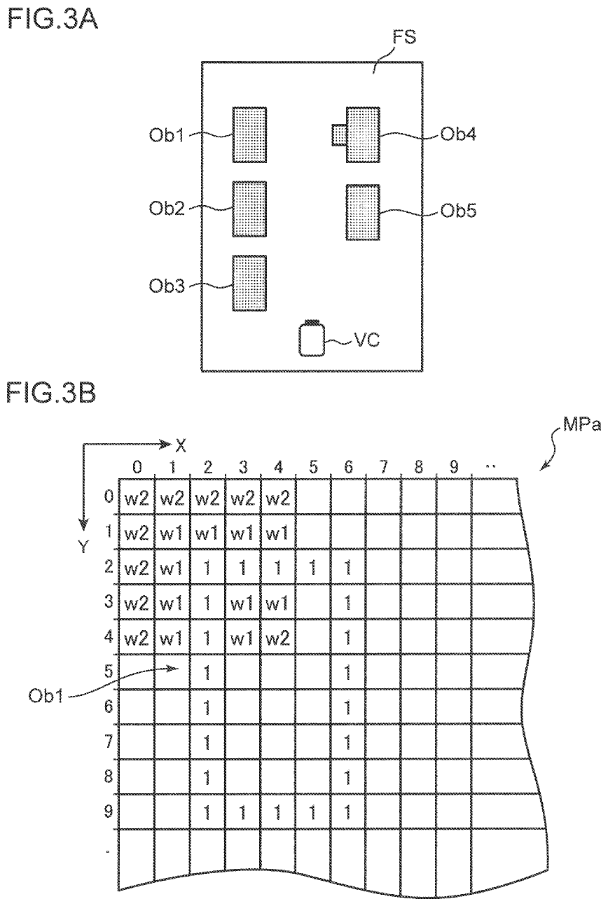

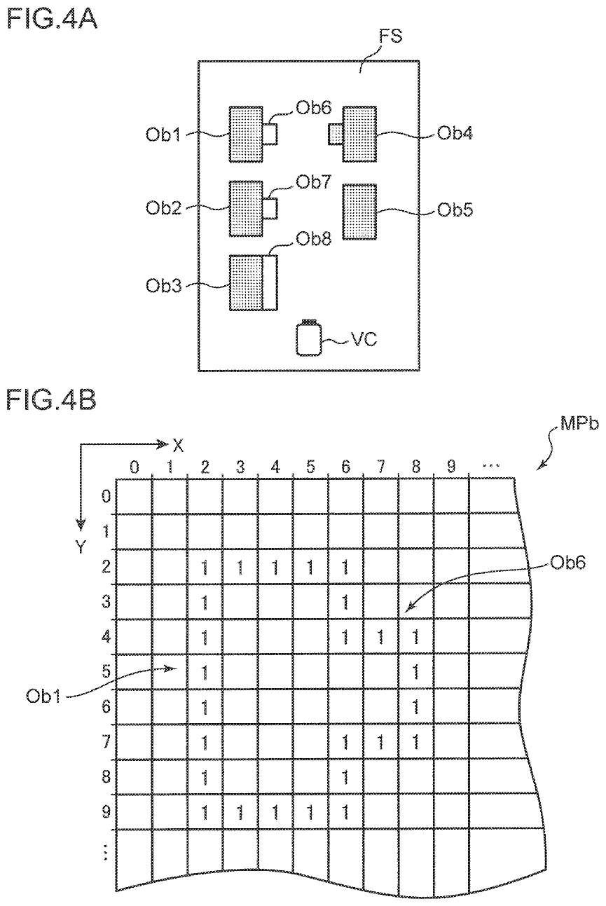

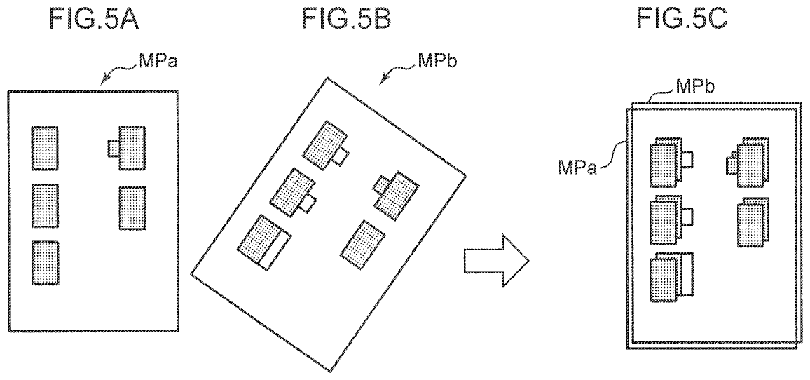

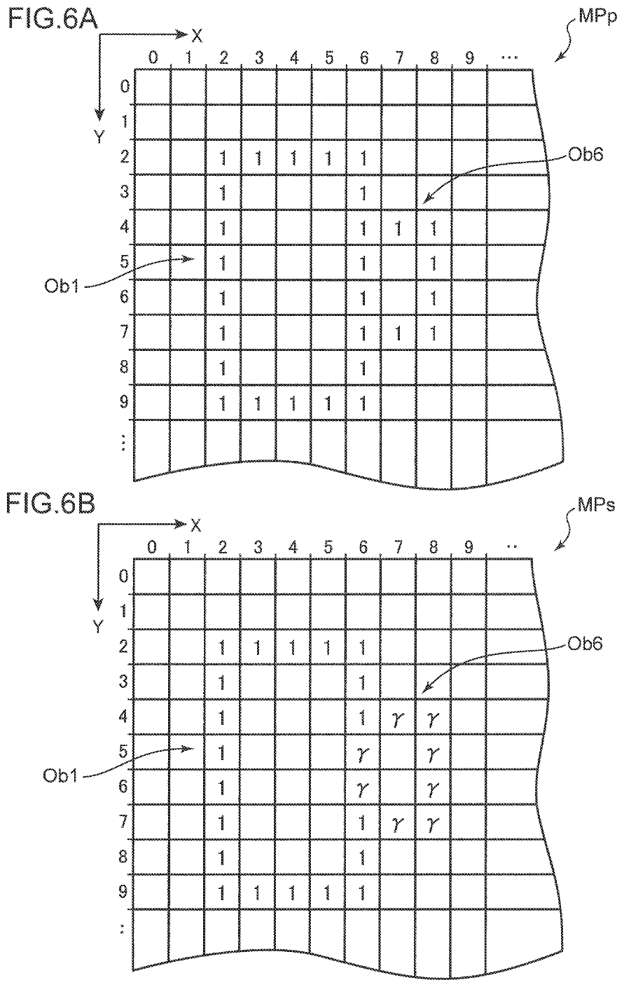

Initially, the operation of creating an environment map for estimating a self-position will be described. FIG. 2 is a flowchart showing the operation of creating the environment map for estimating the self-position in the autonomous mobile vehicle. FIGS. 3A and 3B are views for explaining, as an example, a first environment and a first sub-environment map in the first environment. FIG. 3A shows a predetermined space (region) FS in the first embodiment. FIG. 3B shows a part of a first sub-environment map MPa. FIGS. 4A and 4B are views for explaining, as an example, a second environment and a second sub-environment map in the second environment. FIG. 4A shows a predetermined space (region) FS in the second environment. FIG. 4B shows a part of a second sub-environment map MPb. FIGS. 5A-5C are views for explaining a way of superposing the first sub-environment map and the second sub-environment map in creating the environment map for estimating the self-position. FIG. 5A schematically shows the first sub-environment map MPa, and FIG. 5B schematically shows the second sub-environment map MPb rotating with respect to the first sub-environment map MPa. FIG. 5C schematically shows a state where the first sub-environment map MPa and the second sub-environment map MPb superposed on each other by the rotation of the second sub-environment map MPb. FIGS. 6A and 6B are views for explaining, as an example, the environment map for estimating the self-position. FIG. 6A shows a part of an environment map MPp for estimating the self-position created by superposing the first and second sub-environment maps MPa, MPb so that respective peripheral portions of the sub-environment maps meet each other as shown in FIG. 5C, and executing the OR operation onto superposed points respectively on the first and second sub-environment maps MPa, MPb. FIG. 6B shows a part of an environment map MPs for estimating the self-position where a value of an object presence likelihood degree LH at a first point on the environment map MPp for estimating the self-position shown in FIG. 6A is changed from a set value 1 to an adjustment value (weight value) γ depending on a distance between the points at the first point.

The autonomous mobile vehicle VC (the environment map creation device, the self-position estimation system) having the above-described configuration initializes each of the parts and the like as needed when its unillustrated power source is turned on, and then restarts the operations thereof. The control processor 4 operably establishes each of the control part 41, the self-position estimation part 42, the adjustment part 43, and the environment map creation part 44 by executing a corresponding control processing program.

In response to an instruction of a start of creating the environment map for estimating the self-position from a user (operator), the autonomous mobile vehicle VC collects, as a first measurement result, data of a direction toward an object and a distance to the object by the environment recognition sensor 1 in the first embodiment (S11), and creates, based on the first measurement result measured by the environment recognition sensor 1 in the first environment, an environment map as a first sub-environment map (S12) as shown in FIG. 2.

More specifically, the autonomous mobile vehicle VC moves in a predetermined space in the first environment through, for example, a circular route, and the environment recognition sensor 1 measures, during the movement, the data of the direction toward the object and the distance to the object as the first measurement result at predetermined sampling intervals, and outputs the first measurement result to the control processor 4. The predetermined space is a certain space for allowing the autonomous mobile vehicle to perform autonomous movement therein, e.g., a facility like a factory and a building. The autonomous mobile vehicle VC is a device suitable for various purposes, for example, may be a delivery vehicle or a transport vehicle (transport robot) which carries goods, a cleaning vehicle or a cleaning robot which performs cleaning, and a patrol vehicle (patrol robot) which performs a security patrol. The autonomous mobile vehicle VC in the embodiment serves as, for example, a transport vehicle which carries loads in a factory. The first environment represents a situation where a predetermined object, e.g., a manufacturing apparatus and appliance, is arranged in the predetermined space. The first creation section 441 of the environment map creation part 44 creates, based on the first measurement result, the first sub-environment map. For instance, the first creation section 441 creates the first sub-environment map by employing a known SLM (Simultaneous Localization and Mapping) way. The SLAM way represents a technology of estimating a self-position and creating an environment map while moving. The SLAM way includes firstly determining an initial self-position (start position) and creating an environment map at a current time t=0. This way further includes: subsequently estimating a self-position at a time t+1; modifying, based on an environment map at a time t, the estimated self-position; creating an environment map at the time t+1; and updating the environment map created at the time t. Thereafter, the steps are repeated. A Loop Closure for decreasing a cumulative error may be executed by measuring the same point through the circuit route one time when the SLM way is used to create the environment map. In the Loop Closure, a start position may agree with a finish position in the circuit route. Alternatively, the finish position to the start position is recognizable by estimating the start position and the finish position even when the positions disagree. In this manner, the Loop Closure is attainable.

When step S11 and step S12 are executed in the aforementioned manner for the predetermined space FS in the first environment including five objects Obl to Ob5 at respective predetermined positions therein, the first sub-environment map MPa in the first environment shown in FIG. 3B is created. FIG. 3B shows a part of the first sub-environment map MPa including the object Ob1. FIG. 3B shows an example where the first sub-environment map MPa is expressed with the object presence likelihood degree LH at a certain point in an XY-rectangular coordinate system having a coordinate origin on a left upper corner of the paper. The object presence likelihood degree LH takes a value ranging from 0 to 1, as described above. An object presence likelihood degree LH at a point where an object is determined to exist is defined as 1, and an object presence likelihood degree LH at a point where no object exists is defined as 0 through the execution of steps S11 and S12 described above. Each point around the point where the object is determined to exist is also allotted an object presence likelihood degree LH (LH<1 in this example) to obtain a predetermined distribution (e.g., a Gaussian distribution) having a peak of the object presence likelihood degree LH (LH=1 in this example) at the point where the object is determined to exist. In the example shown in FIG. 3B, an object presence likelihood degree LH at a certain point corresponding to the position on the surface of the object Ob1 is defined as 1. For convenience of the illustration, FIG. 3B illustrates object presence likelihood degrees of w1, w2 (0<w2<w1<1) allotted to points (0, 0) to (4, 4) around the point (2, 2) where the object is determined to exist, and omits description (illustration) of the object presence likelihood degree of w1, w2 allotted to points around remaining points, other than (2, 2), where the object is determined to exist and of an object presence likelihood degree 0 at the point where no object is determined to exist. Here, the object presence likelihood degree LH at each of points (4, 1) and (4, 3) is allotted w2 with respect to point (2, 2), and allotted w1 with respect to each of points (3, 2), (4, 2), and (5, 2). The object presence likelihood degree LH at each of points (1, 4) and (3, 4) is defined in the same manner. Besides, the environment map illustrated and described below similarly omits the description (illustration) of w1, w2, 0.

Next, the user changes the predetermined space from the first environment to the second environment. For instance, the predetermined space FS in the first environment shown in FIG. 3A additionally includes three objects Ob6 to Ob8 at predetermined positions therein, as shown in FIG. 4A. In the example shown in FIG. 4A, the object Ob6 comes into contact with (mounted to) the object Ob1, the object Ob7 comes into contact (mounted to) the object Ob2, and the object Ob8 comes into contact with (mounted to) the object Ob3. The additional objects Ob6 to Ob8 in this arrangement include, for example, an attachment of a manufacturing apparatus, a feeder vehicle for a parts mount apparatus, a workbench (work table), a parts box, and a tool box selectable suitably for a purpose of the predetermined space and a type thereof. In an example, an environment of an object Ob always being present in the predetermined space FS is expressible as the first environment, and an environment of an object Ob to be appropriately arranged on demand is expressible as the second environment. Arrangement of all the additional prospective objects Ob in the predetermined space FS in the first environment achieves more accurate estimation of the self-position even with the change from the first environment.

Referring back to FIG. 2, the autonomous mobile vehicle VC subsequently collects data of the direction toward the object and the distance to the object as a second measurement result by the environment recognition sensor 1 in the second environment (S13), and creates, based on the second measurement result measured by the environment recognition sensor 1 in the second environment, an environment map as a second sub-environment map (S14). Steps S13 and S14 respectively executed in the same manner as steps S11 and S12 described above. Steps 13 and 14 described above are executed to the predetermined space FS in the second environment shown in FIG. 4A to thereby create the second sub-environment map MPb in the second environment shown in FIG. 4B. FIG. 4B shows a part of the second sub-environment map MPb including the object Ob1 and the object Ob6. In the example shown in FIG. 4B, the object presence likelihood degree LH at a certain point corresponding to a position of a surface of each of the objects Ob1 and Ob6 is defined as 1 except positions of the surfaces hidden due to a contact between the object Ob1 and the object Ob6. That is, the object presence likelihood degree LH at each of the points corresponding to the positions on the surfaces hidden due to the contact between the object Ob1 and the object Ob6 is defined as 0.

Subsequently, the autonomous mobile vehicle VC creates, based on the first and second sub-environment maps created by the first creation section 441, an environment map for estimating a self-position (S15).

More specifically, the second creation section 442 creates the environment map for estimating the self-position by superposing the first and second sub-environment maps created by the first creation section 441 so that respective peripheral portions of the first and second sub-environment maps meet each other. Furthermore, a point Pbk (k=1, 2, 3, . . . M) on the second sub-environment map MPb nearest to a corresponding point Paj (j=1, 2, 3, . . . , N) on the first sub-environment map MPa is associated with the point Paj (nearest neighbor points are associated with each other), and a translative amount and a rotational amount of the second sub-environment map MPb with respect to the first sub-environment map MPa are repetitively obtained through a convergent calculation so that a sum of a Euclid distance between the corresponding points Paj, Pbk is minimum. Consequently, the second sub-environment map MPb is superposed on the first sub-environment map MPa. As described above, for instance, the second sub-environment map MPb shown in FIG. 5B is translated and rotated to be superposed on the first sub-environment map MPa shown in FIG. 5A, as shown in FIG. 5C. For convenience of the illustration, FIG. 5C illustrates the first sub-environment map MPa and the second sub-environment map MPb so that respective peripheral portions of the sub-environment maps deviate from each other. Although the second sub-environment map MPb is superposed on the first sub-environment map MPa here, the first sub-environment map MPa may be superposed on the second sub-environment map MPb.

When creating the environment map for estimating the self-position in the superposition manner, the second creation section 442 obtains a value at a certain point on the environment map for estimating the self-position by executing the OR operation onto superposed points on the first and second sub-environment maps created by the first creation section 441. For instance, the corresponding superposed points respectively on the first sub-environment map MPa shown in FIG. 3B and the second sub-environment map MPb shown in FIG. 4B are subjected to the OR operation to obtain a value on each point on the environment map for estimating the self-position. In each of the examples shown in FIG. 3B and FIG. 4B, the first sub-environment map MPa and the second sub-environment map MPb are superposed so that point (0, 0) on the first sub-environment map and point (0, 0) on the second sub-environment map meet each other, and the value 0 of the object presence likelihood degree LH at the point (0, 0) on the first sub-environment map MP and the value 0 of the object presence likelihood degree LH at the point (0, 0) on the second sub-environment map MPb are subjected to the OR operation, and the value 0 is defined as value 0 of the object presence likelihood degree LH at point (0, 0) on the environment map for estimating the self-position. For instance, the first sub-environment map MPa and the second sub-environment map MPb are superposed so that point (6, 2) on the first sub-environment map and point (6, 2) on the second sub-environment map meet each other, and the value 1 of the object presence likelihood degree LH at the point (6, 2) on the first sub-environment map MPa and the value 1 of the object presence likelihood degree LH at the point (6, 2) on the second sub-environment map MPb are subjected to the OR operation, and the value 1 is defined as value 1 of the object presence likelihood degree LH at point (6, 2) on the environment map for estimating the self-position. Moreover, for instance, the first sub-environment map MPa and the second sub-environment map MPb are superposed so that point (8, 4) on the first sub-environment map and point (8, 4) on the second sub-environment map meet each other, and the value 0 of the object presence likelihood degree LH at the point (8, 4) on the first sub-environment map MPa and the value 1 of the object presence likelihood degree LH at the point (8, 4) on the second sub-environment map MPb are subjected to the OR operation, and the value 1 is defined as value 1 of the object presence likelihood degree LH a point (8, 4) on the environment map for estimating the self-position. Consequently, the environment map MPp for estimating the self-position shown in FIG. 6A is created from the first sub-environment map MPa shown in FIG. 3B and the second sub-environment map MPb shown in FIG. 4B.

The environment map MPp for estimating the self-position created in this manner is stored in the environment map information storage part 81 and available for estimating the self-position. In the embodiment, subsequent step S16 is executed.

Referring back to FIG. 2, further, the second creation section 442 sets a value of an object presence likelihood degree LH at a first point on the environment map for estimating the self-position depending on a distance between a first sub-point corresponding to the first point on the first sub-environment map and a second sub-point corresponding to the first point on the second sub-environment map by changing the value of the object presence likelihood degree LH at the first point from the set value 1 to an adjustment value (weight value) γ when creating the environment map for estimating the self-position (after execution of the OR operation). In the embodiment, the second creation section 442 determines whether the distance between the first sub-point and the second sub-point at the first point on the environment map for estimating the self-position is equal to or longer than a threshold Th (S16). When the distance is equal to or longer than the threshold Th (Yes) as a result of the determination, the second creation section 442 subsequently executes step S17, and thereafter proceeds to step S18. Conversely, when the distance is not equal to or longer than the threshold Th (the distance is shorter than the threshold Th, No) as a result of the determination, the second creation section 442 subsequently executes step S18.

The second creation section 442 adjusts the object presence likelihood degree at the first point by changing the object presence likelihood degree LH at the first point from the set value 1 to the adjustment value γ in step S17, and then executes step S18.

The second creation section 442 changes the value of the object presence likelihood degree at a first point on the environment map for estimating the self-position from the set value 1 to the adjustment value (weight value) γ when the distance between the first sub-point and the second sub-point at the first point is equal to or longer than the predetermined threshold Th, or maintains the value of the object presence likelihood degree at the first point without changing the same when the distance is shorter than the predetermined threshold Th through steps S16 and S17 described above. In this way, for instance, the environment map MPp shown in FIG. 6A is changed to the environment map MPs shown in FIG. 6B. Specifically, concerning the first sub-environment map and the second sub-environment map, a distance between a specific point where an object is supposed to exist on only either of the sub-environment maps and a corresponding point on the other of the sub-environment map is relatively long and thus exceeds the predetermined threshold Th. Accordingly, the object presence likelihood degree LH is changed to the adjustment value γ. Conversely, the distance between the points where the object is supposed to exist respectively on both the sub-environment maps is relatively short and thus shorter than the predetermined threshold Th. Accordingly, the object presence likelihood degree LH remains unchanged.

In step S18, the autonomous mobile vehicle VC causes the environment map information storage part 81 of the storage 8 to store the environment map for estimating the self-position created in the aforementioned-manner by the environment map creation part 44, and then finishes the process.

The environment map for estimating the self-position is created and stored in the environment map information storage part 81 through execution of each step.

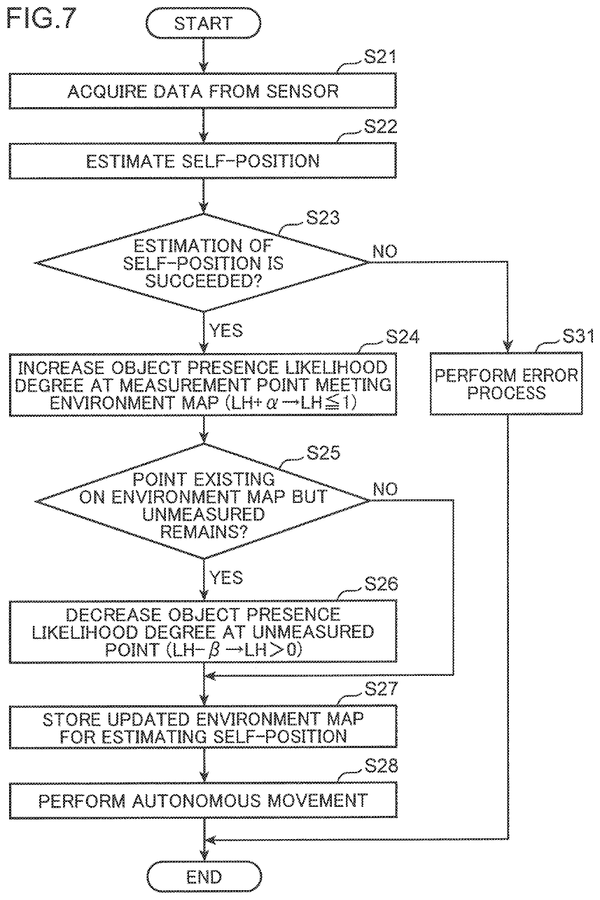

Next, the operation of estimating the self-position and the operation of autonomous movement will be described. FIG. 7 is a flowchart showing the operation of estimating the self-position to be performed in the autonomous mobile vehicle.

Moreover, the autonomous mobile vehicle VC performs autonomous movement while estimating a self-position thereof by repetitively executing steps to be described below at predetermined time intervals in response to an instruction of a start of the autonomous movement from a user (operator).

In FIG. 7, first, the autonomous mobile vehicle VC collects, as a third measurement result, data of a direction toward an object and a distance to the object by the environment recognition sensor 1 (S21).

Next, the autonomous mobile vehicle VC causes the self-position estimation part 42 of the control processor 4 to estimate, based on the third measurement result measured by the environment recognition sensor 1 in step S21 and an environment map for estimating the self-position stored in the storage 8, the self-position by employing a generally known way, e.g., scan matching way and a particle filter way (S22). An odometry way may be used for estimating the self-position instead. Alternatively, so-called sensor fusion with the self-position estimated by employing the odometry way may be executed to estimate the self-position. The sensor fusion is a well-known way to obtain a single result by integrating or fusing respective results obtained from a plurality of sensors with the aim of reducing errors or misrecognition. To this end, the autonomous mobile vehicle VC may further include an odometry sensor 3 connected to the control processor 4 denoted by a dashed line shown in FIG. 1 for measuring an odometry in accordance with a control of the control processor 4. The odometry sensor 3 includes, for example, a rotary encoder which measures a rotational amount of each of the left and right wheels, such as drive wheels and auxiliary wheels, in the moving part 2. The control processor 4 obtains, as the odometry, a moving direction and a moving amount of the autonomous mobile vehicle VC, based on the rotational amount.

Subsequently, the autonomous mobile vehicle VC determines whether the likelihood update section 431 of the adjustment part 43 in the control processor 4 succeeds in estimating the self-position in step S22 (S23). When succeeding in the estimation of the self-position (Yes) as a result of the determination, the autonomous mobile vehicle VC then proceeds to step S24. Conversely, when failing in the self-position (No) as a result of the determination, the autonomous mobile vehicle VC then proceeds to step S31.

In step S31, the autonomous mobile vehicle VC causes the control processor 4 to execute a predetermined error process which is defined in advance, and finishes the process. The predetermined error process may be appropriately set to, for example, notify an error in estimating the self-position to a higher program than a program of the error process.

In step S24, the autonomous mobile vehicle VC causes the likelihood update section 431 to increase an object presence likelihood degree LH at a measurement point measured in step S21 and corresponding to the environment map for estimating the self-position stored in the environment map information storage part 81 by an increase value α (LH+α→LH≤1), and thereafter proceeds to step S25. For instance, when an attachment remains attached, the presence likelihood of the attachment increases on the environment map for estimating the self-position, and thus the attachment is regarded as an object always being present. Adjustment of the increase value α results in achievement in regulation of a speed of the increase in the likelihood. Here, when the object presence likelihood degree LH having increased by the increase value α is about exceed an upper limit of the object presence likelihood degree LH, the object presence likelihood degree LH is cramped (fixed) at the upper limit. In the embodiment, the upper limit of the object presence likelihood degree LH indicates 1, and therefore, the object presence likelihood degree LH never exceeds the upper limit 1 as a result of the execution of step S24.

In step S25, the autonomous mobile vehicle VC causes the likelihood update section 431 to determine whether there is a point existing on the environment map for estimating the self-position stored in the environment map information storage part 81 while remaining unmeasured in step S21. When there is no point remaining unmeasured (No) as a result of the determination, the autonomous mobile vehicle VC subsequently proceeds to step S27. Conversely, when there is a point remaining unmeasured (Yes) as a result of the determination, the autonomous mobile vehicle VC executes step S26, and thereafter proceeds to step S27.

In step S26, the autonomous mobile vehicle VC causes the likelihood update section 431 to decrease the object presence likelihood degree LH on the environment map for estimating the self-position by a decrease value β (LH−β→LH≥lower limit) at the point where no object is measured, based on the third measurement result measured by the environment recognition sensor 1. Therefore, for example, when an attachment is not continuously attached as prospected, the presence likelihood of the attachment degreases so that the presence of the attachment fades out from the environment map for estimating the self-position. Adjustment of the decrease value β results in achievement in regulation of a speed of the decrease in the likelihood. Differentiating the increase value α and the decrease value β from each other at absolute values can further lead to differentiation between the speed increase in the likelihood and the speed decrease in the likelihood. Here, when the object presence likelihood degree LH having decreased by the decrease value β is about to reach below a lower limit of the object presence likelihood degree LH, the object presence likelihood degree LH is cramped (fixed) at a low limit. In the embodiment, the lower limit of the object presence likelihood degree LH indicates 0, and therefore, the object presence likelihood degree LH never reaches below 0 as a result of the execution of step S26.

In step S27, the autonomous mobile vehicle VC causes the likelihood setting section 432 of the adjustment part 43 in the control processor 4 to cause the environment map information storage part 81 to store the environment map for estimating the self-position updated through executions of steps S24 to S26 described above, and further to update the environment map for estimating the self-position stored in the environment map information storage part 81, and thereafter, proceeds to step S28.

In step S28, the autonomous mobile vehicle VC controls the moving part 2 based on the estimated self-position, performs the autonomous movement, and finishes the process. For instance, the autonomous mobile vehicle VC moves while avoiding an object (obstacle) expressed on the environment map or an object (e.g., an operator) detected by the environment recognition sensor 1 in advancement from the estimated self-position to a target position set in advance.

The series of steps is repeated at predetermined time intervals so that the autonomous mobile vehicle VC performs the autonomous movement while estimating the self-position thereof.

As described heretofore, each of the environment map creation device for estimating the self-position (the environment recognition sensor 1 and the environment map creation part 44 in the embodiment) as included in the autonomous mobile vehicle VC and the environment map creation method employed in the device for estimating the self-position according to the embodiment includes creating the environment map for estimating the self-position, based on the first sub-environment map in the first environment and the second sub-environment map in the second environment. In the estimation of the self-position using the environment map, the self-position is estimable when a real environment indicates the second environment as well as the first environment, and therefore, the self-position is more accurately estimable. Consequently, the environment map creation device and the environment map creation method succeed in creating the environment map for estimating the self-position so as to enable more accurate estimation of the self-position.

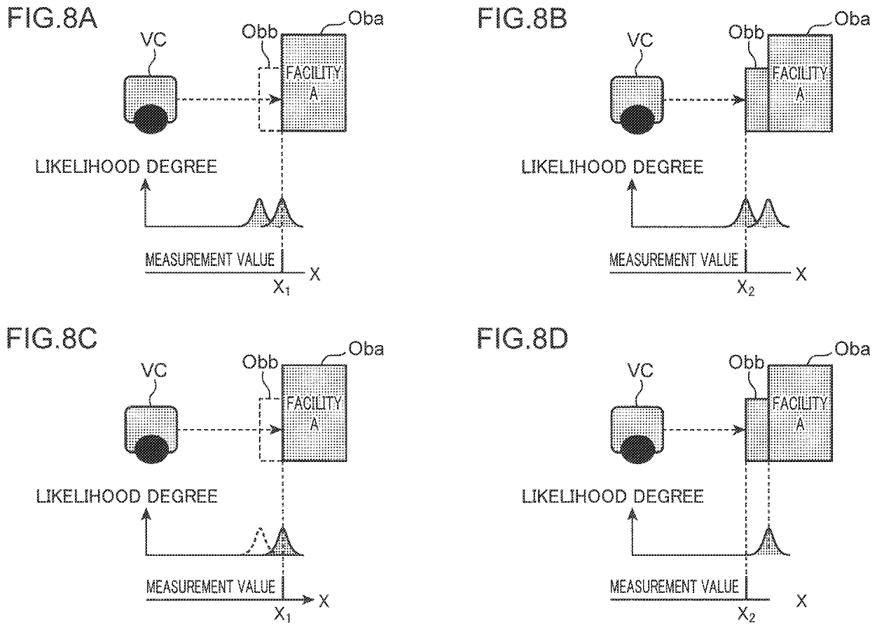

Operational effects in the embodiment will be described in more detail with reference to FIGS. 8A-8D. FIGS. 8A-8D includes views for explaining an operational effect of a first aspect for estimating a self-position in the autonomous mobile vehicle. FIG. 8A shows a third environment serving as a space for allowing the autonomous mobile vehicle VC moves therein. FIG. 8B shows a fourth environment serving as the space. FIG. 8C shows a third environment serving as a space using an environment map of a comparative example. FIG. 8D shows a fourth environment serving as a space using an environment map of the comparative example.

An environment map for estimating a self-position in the comparative example is created for a predetermined space of the third environment having an object (facility A) Oba without an object Obb in the space as shown in FIG. 8C. The third environment corresponds to the above-described first environment.

When the self-position is estimated by using the environment map of the comparative example in the space of the third environment, the environment map of the comparative example including information of the object Oba as shown in FIG. 8C and a measurement result from an environment recognition sensor are collated with each other in a relatively favorable manner. Accordingly, the self-position is accurately estimable. In contrast, when the self-position is estimated by using the environment map of the comparative example in a predetermined space of the fourth environment including the object Oba and the object Obb therein, a difference is seen in the collation between the environment map of the comparative example including no information of the object Obb as shown in FIG. 8D and a measurement result from the environment recognition sensor. Therefore, it is difficult to accurately estimate the self-position. The fourth environment corresponds to the above-described second environment. As described above, the change from the third environment to the fourth environment in the comparative example makes it difficult to accurately estimate the self-position.

In contrast, in the embodiment, an environment map for estimating a self-position is created, based on a first sub-environment map in the third environment and a second sub-environment map in a fourth environment map, as shown in the example in FIGS. 8A-8D. Therefore, when the self-position is estimated in the space of the third environment by using the environment map in the embodiment, the environment map in the embodiment including the information of the object Oba as shown in FIG. 8A and a measurement result from the environment recognition sensor are collated with each other in a relatively favorable manner. Accordingly, the self-position is accurately estimable. Moreover, even when the self-position is estimated by using the environment map in the embodiment in the space of the fourth environment, the environment map in the embodiment including the information of the object Obb as shown in FIG. 8B and the measurement result from the environment recognition sensor are collated with each other in a relatively favorable manner as well. Accordingly, the self-position is accurately estimable. As described above, the self-position is accurately estimable even with the change from the third environment to the fourth environment or the reverse change from the fourth environment to the third environment.

The environment map creation device and the environment map creation method include superposing the first and second sub-environment maps so that respective peripheral portions of the first and second sub-environment maps meet each other. When the first and second environments have the same space, the peripheral portion of the first sub-environment map and the peripheral portion of the second sub-environment map are substantially the same. Therefore, the environment map creation device and the environment map creation method each utilizing the aforementioned characteristics can achieve more accurate creation of the environment map for estimating the self-position even when the first sub-environment map and the second sub-environment map are relatively deviated from each other due to, for example, a rotation.

The environment map creation device and the environment map creation method include setting an object presence likelihood degree at the first point depending on a distance between the first and second sub-points. The distance between the first and second sub-points corresponding to the first point on the environment map for estimating the self-position is relatively close to the first point when an object exists in both the first and second environments, and is relatively far from the first point when the object exists only on either of the first and second environments. In this respect, the environment map creation device and the environment map creation method including setting the object presence likelihood degree at the first point depending on the distance between the first and second sub-points can reflect the change between the first environment and the second environment on the environment map for estimating the self-position.

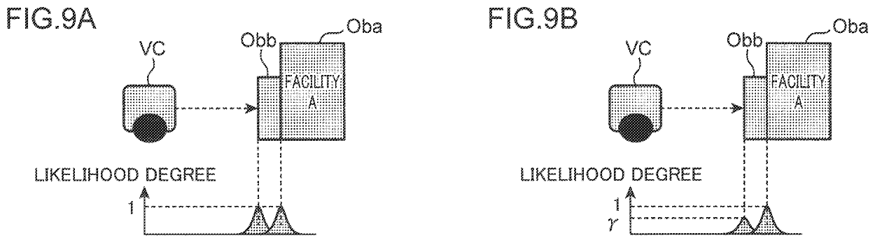

FIG. 9 includes views for explaining an operational effect of a second aspect for estimating a self-position in the autonomous mobile vehicle. FIG. 9A shows a case where an object presence likelihood degree is not adjusted. FIG. 9B shows a case where the object presence likelihood degree is adjusted.

For instance, on an environment map for estimating a self-position, an object presence likelihood degree LH for an object Obb which is not arranged in the third environment but is arranged in the fourth environment and an object presence likelihood degree LH for an object Oba arranged in both the third and fourth environments as shown in FIG. 9A (corresponding to FIG. 6A) may be defined to be equivalent to each other. In this case, the object presence likelihood degree LH for the Object Obb is adjusted relative to the object presence likelihood degree LH for the object Oba as shown in FIG. 9B (corresponding to FIG. 6B). In the example shown in FIG. 9B, the object presence likelihood degree LH for the object Obb is adjusted to be smaller than the object presence likelihood degree LH for the object Oba. Here, the object presence likelihood degree LH for the object Oba may be adjusted to be larger than the object presence likelihood degree LH for the object Obb. Therefore, the environment map creation device and the environment map creation method can reflect the change between the third environment (corresponding to the first environment) and the fourth environment (corresponding to the second environment) on the environment map for estimating the self-position.

As understood from the description using FIGS. 8A-8D, the environment map for estimating the self-position as shown in FIG. 9A (FIG. 6A) may be used as the environment map for estimating the self-position in the embodiment.

The self-position estimation system (the environment recognition sensor 1, the environment map information storage part 81, and the self-position estimation part 42 in the embodiment) included in the autonomous mobile vehicle VC stores the environment map for estimating the self-position created by the environment map creation device, and uses the stored environment map when estimating the self-position, and accordingly can more accurately estimate the self-position.

The environment map creation device and the environment map creation method include creating a single environment for estimating a self-position, based on a first sub-environment map in a first environment and a second sub-environment map in a second environment. Therefore, the self-position estimation system can reduce an information processing amount in the estimation of the self-position more effectively than a configuration of performing collation with each of the first sub-environment map and the second sub-environment map. Hence, use of a self-position estimation system having the same information processing capability leads to a successful reduction in an information processing time.

The autonomous mobile vehicle VC in the embodiment including the above-described self-position estimation system which can more accurately estimate the self-position achieves more appropriate autonomous movement.

The autonomous mobile vehicle VC configured to update, based on the third measurement result and the environment map for estimating the self-position, the environment map for estimating the self-position can update the environment map for estimating the self-position in accordance with a real environment in the autonomous movement, and further can more accurately estimate the self-position even with a change in the environment.

Various aspects of technologies are disclosed in this specification as described above. Main technologies among them will be summarized below.

An environment map creation device according to an aspect is a device for creating an environment map for estimating a self-position. The environment map creation device includes: an environment recognition sensor which measures a direction toward an object and a distance to the object; a first creation section which creates, based on a first measurement result measured by the environment recognition sensor in a first environment, an environment map as a first sub-environment map, and creates, based on a second measurement result measured by the environment recognition sensor in a second environment different from the first environment while including the first environment, an environment map as a second sub-environment map; and a second creation section which creates, based on the first and second sub-environment maps created by the first creation section, the environment map for estimating the self-position.

The environment map creation device creates, based on the first sub-environment map in the first environment and the second sub-environment map in the second environment, the environment map for estimating the self-position. In the estimation of the self-position using the environment map, the self-position is estimable when a real environment indicates the second environment as well as the first environment. Accordingly, the self-position is more accurately estimable. Consequently, the environment map creation device can create the environment map for estimating the self-position so as to enable more accurate estimation of the self-position.

In the environment map creation device according to another aspect, the second creation section creates the environment map for estimating the self-position by superposing the first and second sub-environment maps created by the first creation section so that respective peripheral portions of the first and second sub-environment maps meet each other. In the environment map creation device, preferably, the second creation section obtains a value at a certain point on the environment map for estimating the self-position by executing the OR operation onto superposed points respectively on the first and second environment maps created by the first creation section, and then creates the environment map for estimating the self-position.

When the first and second environments have the same space, the peripheral portion of the first sub-environment map and the peripheral portion of the second sub-environment map are substantially the same. The environment map creation device superposes the first and second sub-environment maps by utilizing the characteristics so that the respective peripheral portions of the first and second sub-environment maps meet each other, and accordingly, can more accurately create the environment map for estimating the self-position even when the first and second sub-environment maps are relatively deviated from each other due to, for example, a rotation.

In the environment map creation device according to further another aspect, the environment map includes an object presence likelihood degree representing a degree of likelihood that an object exists at a certain point, and the second creation section sets a value of an object presence likelihood degree at a first point on the environment map for estimating the self-position depending on a distance between a first sub-point corresponding to the first point on the first sub-environment map and a second sub-point corresponding to the first point on the second sub-environment map when creating the environment map for estimating the self-position.

The distance between the first and second sub-points corresponding to the first point is relatively close to the first point when an object exists in both the first and second environments, and is relatively far from the first point when the object exists only in either of the first and second environments. The environment map creation device configured to set the object presence likelihood degree at the first point depending on the distance between the first and second sub-points can reflect the change between the first environment and the second environment on the environment map for estimating the self-position.

An environment map creation method according to another aspect is a method for creating an environment map for estimating a self-position. The environment map creation method includes: an environment recognition step of measuring a direction toward an object and a distance to the object; a first creation step of creating, based on a first measurement result measured in the environment recognition step in a first environment, an environment map as a first sub-environment map, and creating, based on a second measurement result measured in the environment recognition step in a second environment different from the first environment while including the first environment, an environment map as a second sub-environment map; and a second creation step of creating, based on the first and second sub-environment maps created in the first creation step, the environment map for estimating the self-position.

The environment map creation method includes creating, based on the first sub-environment map in the first environment and the second sub-environment map in the second environment, the environment map for estimating the self-position. In the estimation of the self-position using the environment map, the self-position is estimable when a real environment indicates the second environment as well as the first environment. Consequently, the environment map creation method achieves creation of the environment map for estimating the self-position so as to enable more accurate estimation of the self-position.

A self-position estimation system according to still another aspect includes: the environment map creation device described above; an environment map information storage part which stores the environment map for estimating the self-position created by the environment map creation device; and a self-position estimation part which estimates the self-position, based on a third measurement result measured by the environment recognition sensor and the environment map for estimating the self-position stored in the environment map information storage part. Preferably, the self-position estimation system further includes: the environment map information storage part which stores the environment map for estimating the self-position; the environment recognition sensor which measures a direction toward an object and a distance to the object; and the self-position estimation part which estimates the self-position, based on the measurement result measured by the environment recognition sensor and the environment map for estimating the self-position stored in the environment map information storage part. The environment map for estimating the self-position is an environment map based on the environment map in the first environment and the environment map in the second environment different from the first environment while including the first environment.

The self-position estimation system which stores the environment map for estimating the self-position created by any environment map creation device described above and uses the stored environment map in estimating the self-position can therefore more accurately estimate the self-position.

An autonomous mobile vehicle according to further another aspect includes: the self-position estimation system; a moving part which performs movement of the autonomous mobile vehicle; and an autonomous movement control part which controls the moving part, based on the self-position estimated by the self-position estimation system.

The autonomous mobile vehicle including the self-position estimation system which can more accurately estimate the self-position achieves more appropriate autonomous movement.

According to another aspect, the autonomous mobile vehicle further includes: an adjustment part which updates, based on the third measurement result measured by the environment recognition sensor and the environment map for estimating the self-position stored in the environment map information storage part, the environment map for estimating the self-position and causes the environment map information storage part to store the updated environment map. Preferably, in the autonomous mobile vehicle, the environment map includes an object presence likelihood degree representing a degree of likelihood that the object exists at a certain point on the environment map. Preferably, the adjustment part updates the environment map for estimating the self-position by increasing an object presence likelihood degree at a point, corresponding to a point where the object is measured based on the third measurement result measured by the environment recognition sensor, on the environment map for estimating the self-position, or updates the environment map for estimating the self-position by decreasing an object presence likelihood degree at a point, corresponding to a point where no object is measured based on the third measurement result measured by the environment recognition sensor, on the environment map for estimating the self-position.

The autonomous mobile vehicle configured to update, based on the third measurement result and the environment map for estimating the self-position, the environment map for estimating the self-position can update the environment map for estimating the self-position in accordance with a real environment in the autonomous movement, and further can more accurately estimate the self-position even with a change in the environment.

Although the present disclosure has been fully described by way of embodiments with reference to the accompanying drawings, it is to be understood that various changes and/or modifications will be apparent to those skilled in the art. Therefore, unless otherwise such changes and modified embodiments to be made by those skilled in the art depart from the scope of the present disclosure hereinafter defined, they should be construed as being included therein.

The present disclosure can provide a self-position estimation system and a self-position estimation method for estimating a self-position or own position of the system, and an autonomous mobile vehicle including the self-position estimation system.

1. An environment map creation device for creating an environment map for estimating a self-position, comprising:
an environment recognition sensor configured to measure a direction toward an object and a distance to the object; and
a processor configured to:
create, based on a first measurement result measured by the environment recognition sensor in a first environment, an environment map as a first sub-environment map,
create, based on a second measurement result measured by the environment recognition sensor in a second environment different from the first environment while including the first environment, an environment map as a second sub-environment map; and
create, based on the first and second sub-environment maps created by the first creation section, the environment map for estimating the self-position.

2. The environment map creation device according to claim 1, wherein
the processor is configured to create the environment map for estimating the self-position by superposing the first and second sub-environment maps created by the first creation section so that respective peripheral portions of the first and second sub-environment maps meet each other.

3. The environment map creation device according to claim 1, wherein
the environment map includes an object presence likelihood degree representing a degree of likelihood that an object exists at a certain point, and
the processor is configured to set a value of an object presence likelihood degree at a first point on the environment map for estimating the self-position depending on a distance between a first sub-point corresponding to the first point on the first sub-environment map and a second sub-point corresponding to the first point on the second sub-environment map when creating the environment map for estimating the self-position.

4. An environment map creation method for creating an environment map for estimating a self-position, comprising:
measuring a direction toward an object and a distance to the object;
a first creating process of creating, based on a first measurement result measured in the measuring in a first environment, an environment map as a first sub-environment map, and creating, based on a second measurement result measured in the measuring in a second environment different from the first environment while including the first environment, an environment map as a second sub-environment map; and
a second creating process of creating, based on the first and second sub-environment maps created in the first creating process, the environment map for estimating the self-position.

5. A self-position estimation system comprising:
the environment map creation device according to claim 14;
an environment map information storage configured to store the environment map for estimating the self-position created by the environment map creation device; and
the processor is configured to estimate the self-position, based on a third measurement result measured by the environment recognition sensor and the environment map for estimating the self-position stored in the environment map information storage.

6. An autonomous mobile vehicle, comprising:
the self-position estimation system according to claim 5;
a moving part configured to perform movement of the autonomous mobile vehicle; and
the processor is configured to control the moving part, based on the self-position estimated by the self-position estimation system.

7. The autonomous mobile vehicle according to claim 6, wherein
the processor is configured to update, based on the third measurement result measured by the environment recognition sensor and the environment map for estimating the self-position stored in the environment map information storage, the environment map for estimating the self-position and cause the environment map information storage to store the updated environment map.

8. The environment map creation device according to claim 2, wherein
the environment map includes an object presence likelihood degree representing a degree of likelihood that an object exists at a certain point, and
the processor is configured to set a value of an object presence likelihood degree at a first point on the environment map for estimating the self-position depending on a distance between a first sub-point corresponding to the first point on the first sub-environment map and a second sub-point corresponding to the first point on the second sub-environment map when creating the environment map for estimating the self-position.

9. A self-position estimation system comprising:
the environment map creation device according to claim 2;
an environment map information storage configured to store the environment map for estimating the self-position created by the environment map creation device; and
the processor is configured to estimate the self-position, based on a third measurement result measured by the environment recognition sensor and the environment map for estimating the self-position stored in the environment map information storage.

10. A self-position estimation system comprising:
the environment map creation device according to claim 3;
an environment map information storage configured to store the environment map for estimating the self-position created by the environment map creation device; and
the processor is configured to estimate the self-position, based on a third measurement result measured by the environment recognition sensor and the environment map for estimating the self-position stored in the environment map information storage.

11. A self-position estimation system comprising:
the environment map creation device according to claim 8;
an environment map information storage configured to store the environment map for estimating the self-position created by the environment map creation device; and
the processor is configured to estimate the self-position, based on a third measurement result measured by the environment recognition sensor and the environment map for estimating the self-position stored in the environment map information storage.

12. An autonomous mobile vehicle, comprising:
the self-position estimation system according to claim 9;
a moving part configured to perform movement of the autonomous mobile vehicle; and
the processor is configured to control the moving part, based on the self-position estimated by the self-position estimation system.

13. An autonomous mobile vehicle, comprising:
the self-position estimation system according to claim 10;
a moving part configured to perform movement of the autonomous mobile vehicle; and
the processor is configured to control the moving part, based on the self-position estimated by the self-position estimation system.

14. An autonomous mobile vehicle, comprising:
the self-position estimation system according to claim 11;
a moving part configured to perform movement of the autonomous mobile vehicle; and
the processor is configured to control the moving part, based on the self-position estimated by the self-position estimation system.

15. The autonomous mobile vehicle according to claim 12, wherein
the processor is configured to update, based on the third measurement result measured by the environment recognition sensor and the environment map for estimating the self-position stored in the environment map information storage, the environment map for estimating the self-position and cause the environment map information storage to store the updated environment map.

16. The autonomous mobile vehicle according to claim 13, wherein
the processor is configured to update, based on the third measurement result measured by the environment recognition sensor and the environment map for estimating the self-position stored in the environment map information storage, the environment map for estimating the self-position and cause the environment map information storage to store the updated environment map.

17. The autonomous mobile vehicle according to claim 14, wherein
the processor is configured to update, based on the third measurement result measured by the environment recognition sensor and the environment map for estimating the self-position stored in the environment map information storage, the environment map for estimating the self-position and cause the environment map information storage to store the updated environment map.
